(19) United States
(12) Patent Application Publication
(10) Pub. No.: US 2023/0242139 A1
(43) Pub. Date: Aug. 3, 2023

(54) ALERT OUTPUT METHOD, ALERT OUTPUT DEVICE, COMPUTER PROGRAM, COMPUTER READABLE MEDIUM, VEHICLE ALERT OUTPUT SYSTEM, AND VEHICLE

(71) Applicant: Volvo Truck Corporation, Göteborg (SE)

(72) Inventor: Quentin SIUTKOWSKI, Saitama (JP)

(21) Appl. No.: 18/013,016

(22) PCT Filed: Jul. 2, 2020
(86) PCT No.: PCT/JP2020/026037

§ 371 Date: Dec. 27, 2022

(51) Int. Cl. B60W 50/14; B60W 60/00; G08G 1/16; B60W 30/16; B60W 30/09; B60W 10/18

(52) U.S. Cl. CPC B60W 50/14; B60W 10/182; B60W 30/09; B60W 30/16; B60W 60/0015; G08G 1/16; B60W 10/20; B60W 2554/80; B60W 2554/4029

(57) ABSTRACT

Provided is an autonomous driving vehicle that runs in confined areas, in which an object around the vehicle is detected by a sensing device. In the autonomous driving vehicle, an alert mode is determined depending on the distance between the vehicle and the object. A projection device projects a visible zone surrounding the vehicle on its outside in a manner corresponding to the alert mode.

### TECHNICAL FIELD

The present invention relates to a method, a device, a system, a computer program, and a computer-readable medium for outputting an alert from an autonomous driving vehicle, and relates to such a vehicle.

### BACKGROUND ART

The proportion of industrial accidents caused by vehicles is not small among industrial accidents occurring in different industries. In recent years, autonomous driving vehicles have been used for industrial purposes. It is therefore desired to reduce the risk of accidents with the autonomous driving vehicles used for the industrial purposes and to improve safety. Conventionally, a technique has been proposed to alert the driver when a physical object is detected around the vehicle in order to improve the vehicle driving safety, in a general vehicle equipped with a driving support function. In such technique, it has also been proposed to perform vehicle control such as brake control, engine control, and steering control as necessary in order to avoid collision with the object.

### CITATION LIST

### Patent Literature

PTL 1: JP 5888407 B

### SUMMARY OF INVENTION

### Technical Problem

Unlike general roads, confined areas used for industrial purposes, such as sites for loading and unloading freight containers in ports, wharfs and factory premises, are often not provided with signals or sidewalks, and thus, collision accidents may be likely to occur. In such places, when an autonomous driving vehicle approaches an object such as a pedestrian who is a so-called vulnerable road user (VRU) and/or a vehicle which is driven by a third-party driver, if the other party is aware of whether he or she is recognized by the autonomous driving vehicle or how dangerous the situation is, appropriate actions to avoid collisions may be taken not only by the autonomous driving vehicle but also by the other party.

In the conventional art, although the driver of the vehicle is alerted of danger upon detection of the object, no explicit alert may be given to a person who is outside the vehicle.

Accordingly, it is an object of the present invention to provide a method, a device, a computer program, a computer readable medium and a system for an autonomous driving vehicle that runs in confined areas, which can alert a person outside the vehicle to the approaching state of the vehicle, and to provide such a vehicle.

Accordingly, it is an object of the present invention to provide an autonomous driving vehicle that runs in confined areas which can alert a person outside the vehicle to the approaching state of the vehicle, and its method, device, computer program, computer readable medium, and system.

### Solution to Problem

According to the present invention, in an autonomous driving vehicle that runs in confined areas, when an object is detected around the vehicle by a sensing device, an alert mode is determined depending on a distance between the vehicle and the object. Furthermore, a visible zone surrounding the vehicle on its outside is projected by a projection device in a manner corresponding to the alert mode.

### Advantageous Effects of Invention

According to the present invention, an autonomous driving vehicle which runs in confined areas may alert a person outside the vehicle to the approaching state of the vehicle.

### BRIEF DESCRIPTION OF DRAWINGS

FIG. 1 is a block diagram illustrating an overall configuration of the truck.

FIG. 2 is a flowchart illustrating a process executed by an alert output device of the truck according to the first embodiment.

FIG. 3 is an explanatory view of an alert mode depending on a distance between the truck and an object.

FIG. 4 is an explanatory view of an alert mode depending on a distance between the truck and the object.

FIG. 5 is an explanatory view of an alert mode depending on a distance between the truck and the object.

FIG. 6 is an explanatory view of an alert mode depending on a distance between the truck and the object.

FIG. 7 is an explanatory view of truck platooning according to the second embodiment.

FIG. 8 is a block diagram illustrating the entire configuration of the platooning system according to the second embodiment.

FIG. 9 is a flowchart illustrating a process executed by an alert output device of a truck which is a preceding vehicle according to the second embodiment.

FIG. 10 is a flowchart illustrating a process executed by an alert output device of a truck which is a following vehicle according to the second embodiment.

### DESCRIPTION OF EMBODIMENTS

Hereinafter, embodiments for carrying out the present invention will be described in detail with reference to the accompanying drawings. According to the first embodiment of the present invention, when an object is detected around the autonomous driving vehicle, an alert is output so as to alert a person outside the vehicle to the approaching state of the vehicle and the existence of the object. The vehicle is contemplated to run in confined areas and is used for industrial purposes, for example, at sites for loading and unloading freight containers in ports, wharfs, or factory premises. The object includes any physical object to which collision with the vehicle should be avoided, such as a pedestrian, another vehicle, and an obstacle like a freight container. The vehicle includes any vehicle that can run in confined areas, such as a truck and a construction machine. Furthermore, the autonomous driving vehicle described herein may include a vehicle that performs so-called fully autonomous driving control capable of unmanned driving and a vehicle that performs autonomous driving (driving assistance) control for manned driving.

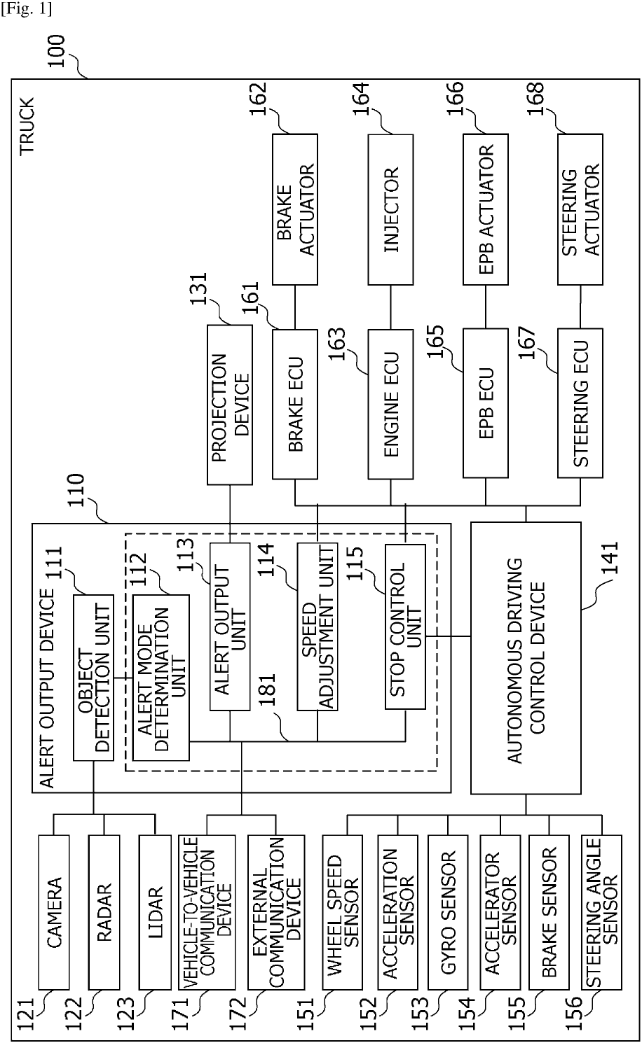

FIG. 1 is the block diagram illustrating the configuration of a truck 100 which is one of the examples of the vehicle according to the first embodiment. The truck 100 includes an alert output device 110, a camera 121, a radar 122, a lidar 123, a projection device 131, an autonomous driving control device 141, a wheel speed sensor 151, an acceleration sensor 152, a gyro sensor 153, an accelerator sensor 154, a brake sensor 155, a steering angle sensor 156, a brake ECU 161, a brake actuator 162, an engine ECU 163, an injector 164, an Electric Parking Brake (EPB) ECU 165, an EPB actuator 166, a steering ECU 167, a steering actuator 168, a vehicle-to-vehicle communication device 171, and an external communication device 172.

The alert output device 110 outputs the alert to the outside of the vehicle when an object is detected around the truck 100. The alert output device 110 includes an object detection unit 111, an alert mode determination unit 112, an alert output unit 113, a speed adjustment unit 114, and a stop control unit 115.

The object detection unit 111 uses the camera 121, the radar 122, and the lidar 123 to detect the object around the truck 100. At this time, the object detection unit 111 also acquires information indicating the distance between the truck 100 and the object.

The alert mode determination unit 112 determines which one of the alert modes should be used to output the alert depending on the distance between the truck 100 and the object. Each alert mode corresponds to one danger level and defines how such alert should be issued. The alert modes will be described later in detail.

The alert output unit 113 uses the projection device 131 to project a visible zone 300 surrounding the truck 100 on its outside in a manner corresponding to the alert mode that has been determined by the alert mode determination unit 112.

The speed adjustment unit 114 outputs the control signal to the brake ECU 161 and the engine ECU 163 such that the truck 100 runs at a predetermined speed or less depending on the alert mode.

The stop control unit 115 outputs the control signal to the autonomous driving control device 141 so as to cancel the autonomous driving control of the truck 100, when the truck 100 stops in response to the alert mode and the distance between the truck 100 and the object remains within the predetermined range for a predetermined period of time or longer.

The camera 121 may, for example, be a digital camera that uses an image pick-up device such as CCD and CMOS. The camera 121 is installed at any location on the truck 100 to image the surroundings of the truck 100.

The radar 122 emits electromagnetic waves such as millimeter waves. The radar 122 which is installed at any location on the truck 100 detects the position of the object by detecting the reflection of the electromagnetic waves that are emitted to the surroundings of the truck 100 and then reflected by the object. The radar 122 can detect the distance to the object.

The lidar 123 emits short-wavelength electromagnetic waves such as ultraviolet light, visible light, and near-infrared light in a pulse form. The lidar 123 which is installed at an any location on the truck 100 detects the position of the object by detecting the scattered waves of the electromagnetic waves that are emitted to the surroundings of the truck 100 and then scattered by the object. The lidar 123 can also detect the distance to the object.

The object detection unit 111 uses at least one of or a combination of the camera 121, the radar 122, and the lidar 123 to detect the object around the truck 100 and acquires information indicating the distance to the object.

The projection device 131 projects the visible zone 300 surrounding the truck 100, and may, for example, be a high-brightness LED light bar, a laser light that emits a laser beam, and a projector that can project an image or a video image (in other words, the projection device 131 can also be called the illumination device 131, and the illumination device 131 illuminates a zone surrounding the truck 100 so that the zone is visible to a person outside the truck 100). Any number of the projection devices 131 may be installed at any location at which the light can be projected on the ground around the truck 100 (for example, the lower portion of the vehicle, specifically, front, side, and rear mounting locations of the vehicle entry prevention device). The projection device 131 projects different colors of light based on electronic control. Additionally, the projection device 131 projects the visible zone 300 with a brightness that can be clearly recognized irrespective of day and night.

The autonomous driving control device 141 performs autonomous driving control of the truck 100 based on the inputs from the various vehicle sensors which will be described below.

The wheel speed sensor 151 detects the rotational speed of each wheel as a signal so that it can calculate the drive speed. The acceleration sensor 152 detects the acceleration of the truck 100 in the front-back direction, vehicle width direction, and vertical direction. The gyro sensor 153 detects the angular rate at which the truck 100 rotates around three axes which are the roll, pitch, and yaw axes.

The accelerator sensor 154 detects the pedaling amount (accelerator position) of the accelerator pedal. The brake sensor 155 detects the pedaling amount of the brake pedal (brake operation amount). The steering angle sensor 156 detects the steering amount (steering angle) of the steering wheel.

The brake ECU 161 calculates the brake operation amount based on the input signal, and outputs the brake control signal to the brake actuator 162. The brake actuator 162 generates the air or hydraulic pressure which acts on the brake based on the control signal, and controls the brake torque that is generated on each wheel.

The engine ECU 163 calculates the engine control amount based on the input signal, and outputs the control signal to the injector 164. Then, the injector 164 adjusts the fuel injection amount based on the control signal to adjust the output of the engine. Consequently, the engine torque is controlled.

The EPB ECU 165 outputs the control signal to the EPB actuator 166 in response to the electric parking brake actuation command. The EPB actuator 166 actuates the electric parking brake in response to the control signal.

The steering ECU 167 calculates the steering angle based on the steering amount of the steering wheel, and outputs the control signal to the steering actuator 168. The steering actuator 168 controls power steering based on the control signal.

The vehicle-to-vehicle communication device 171 performs vehicle-to-vehicle (V2V) communication transmitting and receiving a variety of information through wireless communication between the vehicle and other trucks that are driving in the confined area.

The external communication device 172 transmits and receives a variety of information between the truck 100 and the external system through wireless communication.

The communication by the vehicle-to-vehicle communication device 171 and the external communication device 172 can both be realized, for example, by the short-range wireless communication that uses a frequency dedicated for the communication in the confined area; however, the communication method is not limited thereto.

The above-described components are connected to one another through the in-vehicle network 181. The in-vehicle network 181 may, for example, be Controller Area Network (CAN), Local Interconnect Network (LIN), Ethernet (registered trademark), and FlexRay.

The alert output device 110, autonomous driving control device 141, and ECUs such as the brake ECU 161, engine ECU 163, EPB ECU 165 and steering ECU 167 are computers which respectively include the processor, SRAM, FROM, communication interface, and internal bus for connecting them to allow intercommunication. The processor is hardware that executes the instruction set described in the program (data transfer, operation, processing, control, management and the like), and includes the arithmetic unit, register for storing instructions and information, peripheral circuits, and the like. SRAM is the volatile memory that loses data when the power supply is cut off, and provides the temporary storage area that is used by the processor during operation. FROM is the nonvolatile memory that can electrically rewrite data, and stores the program including the program code and various data which are used for operating the program. The program can be stored in the readable medium, for example, a magnetic disk, an optical memory disk, a magnetic-optical disk, a flash memory and the like. The communication interface includes, for example, the CAN transceiver, and provides the connecting function to the in-vehicle network 181.

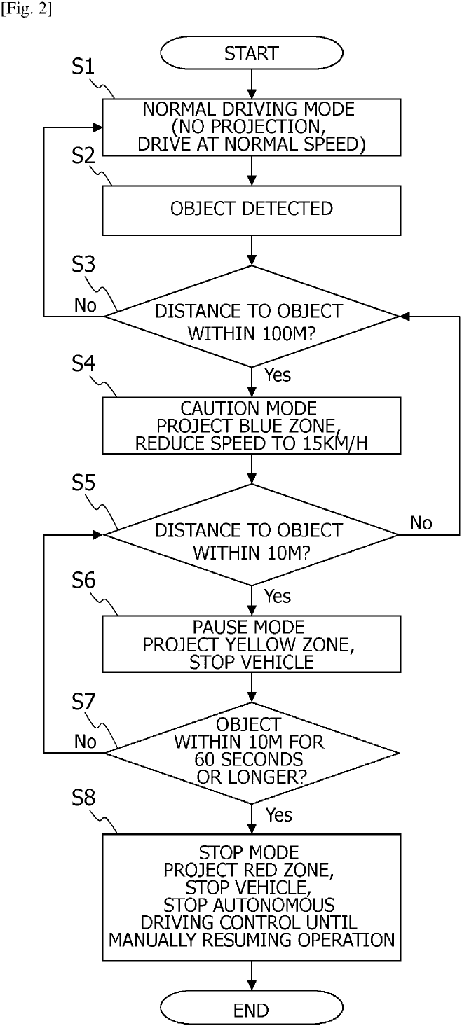

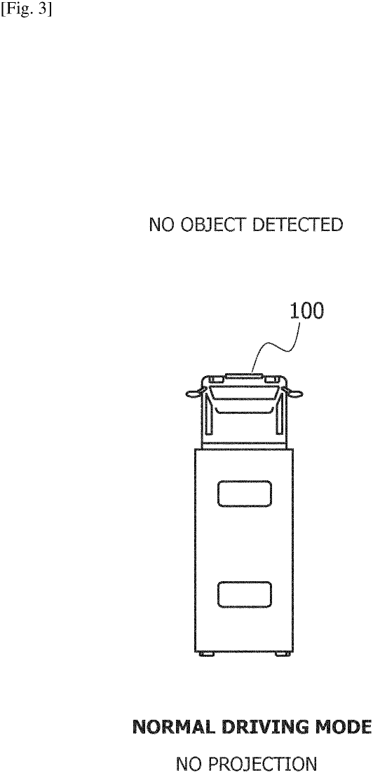

The process executed by the alert output device 110 of the truck 100 will now be explained with reference to the flowchart of the process as illustrated in FIG. 2 and the explanatory view of the alert mode depending on the distance between the truck 100 and the object 200 as illustrated in FIGS. 3 to 6.

In Step 1 in FIG. 2 (denoted as S1 in the figure, and the same applies hereinafter), the truck 100 runs in the state in which no object 200 is detected in the surroundings, that is, runs in the normal driving mode. In the present embodiment, the object detection range is within the range of 100 meters from the truck 100 in the driving direction of the truck 100 and 3 meters from the truck 100 in other directions. FIG. 3 illustrates the state of the truck 100 in the normal driving mode, and the truck 100 runs at a normal speed.

In Step 2, the object detection unit 111 of the alert output device 110 uses at least one selected from the group of the camera 121, radar 122, and lidar 123 to detect an object around the truck 100. At this time, the object detection unit 111 also acquires information indicating the distance between the truck 100 and the object 200.

In Step 3, the alert mode determination unit 112 determines whether or not the distance between the truck 100 and the object 200 is within 100 meters in the driving direction (within 3 meters in other directions). If the distance is within 100 meters, the process proceeds to Step 4 (Yes). Otherwise, the process returns to Step 1.

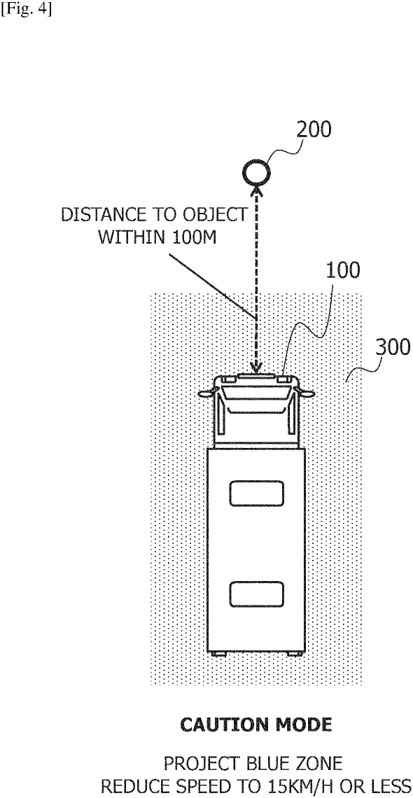

In Step 4, the alert mode determination unit 112 determines the alert mode to be the “caution mode”, because the distance between the truck 100 and the object 200 is within 100 meters. Then, as illustrated in FIG. 4, the alert output unit 113 uses the projection device 131 to project the “blue” visible zone 300 surrounding the truck 100 on its outside. At this time, since the possibility of a collision is higher in the driving direction of the truck 100, the projection range of the visible zone 300 is longer in the driving direction of the truck 100. Additionally, in order for the drive speed of the vehicle to be equal to or less than 15 km/h, the speed adjustment unit 114 outputs the control signal to the brake ECU 161 and outputs the control signal to the engine ECU 163, as necessary.

In Step 5, the alert mode determination unit 112 determines whether or not the distance between the truck 100 and the object 200 is within 10 meters in the driving direction (within 3 meters in other directions). If the distance is within 10 meters, the process proceeds to Step 6 (Yes). Otherwise, the process returns to Step 3.

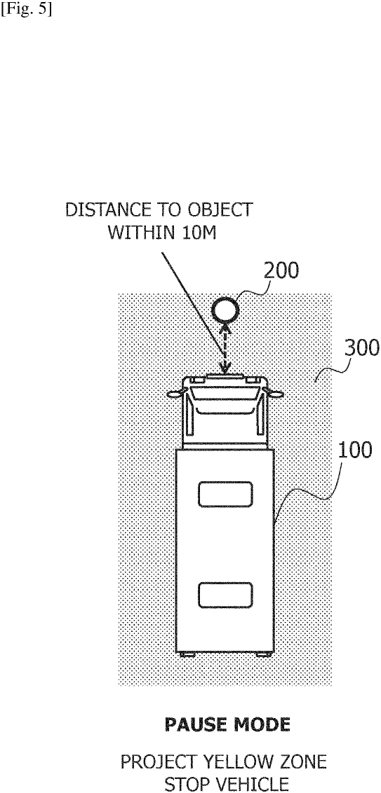

In Step 6, the alert mode determination unit 112 determines the alert mode to be the “pause mode”, because the distance between the truck 100 and the object 200 is within 10 meters. Then, as illustrated in FIG. 5, the alert output unit 113 uses the projection device 131 to project the “yellow” visible zone 300 surrounding the truck 100 on its outside. Additionally, in order to stop the vehicle, the speed adjustment unit 114 outputs the control signal to the brake ECU 161 and outputs the control signal to the engine ECU 163, as necessary. At this time, the control signal for disengaging the clutch may be transmitted to the transmission ECU (not shown), as necessary. Furthermore, the stop control unit 115 outputs the control signal for actuating the electric parking brake to the EPB ECU 165.

In Step 7, the alert mode determination unit 112 determines whether or not the state in which the distance between the truck 100 and the object 200 is within 10 meters in the driving direction (within 3 meters in other directions) continues for 60 seconds or longer. If the state continues for 60 seconds or longer, the process proceeds to Step 8 (Yes). Otherwise, the process returns to Step 5.

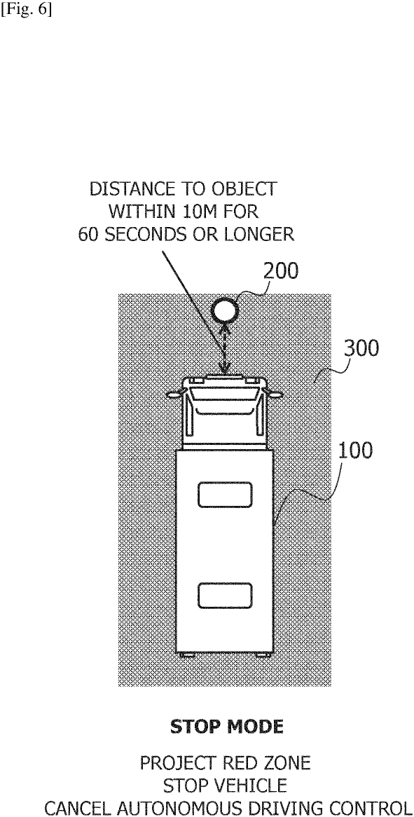

In Step 8, the alert mode determination unit 112 determines the alert mode to be the “stop mode”, because the state in which the distance between the truck 100 and the object 200 is within 10 meters in the driving direction (within 3 meters in other directions) continues for 60 seconds or longer. Then, as illustrated in FIG. 6, the alert output unit 113 uses the projection device 131 to project the “red” visible zone 300 surrounding the truck 100 on its outside. At this time, the vehicle already stops, because the vehicle has gone through the “pause mode”. Then, the stop control unit 115 outputs the control signal for canceling the autonomous driving control to the autonomous driving control device 141. The autonomous driving control is not resumed until the driver manually performs the operation to resume the autonomous driving control. The operation to manually resume the autonomous driving control may, for example, be an operation to turn on the autonomous driving control switch, or an operation to turn off the ignition switch once and then turn on the ignition switch again.

According to the present embodiment, the visible zone 300 surrounding the truck 100 on its outside is projected in a manner corresponding to the alert mode depending on the distance between the truck 100 and the object 200. Accordingly, if the object 200 is the other party such as a pedestrian or a third-party driver of another vehicle, the other party can know that the truck 100 is approaching, and that the other party is detected by the truck 100 and is alerted of danger level. The other party can therefore perform the appropriate operation to avoid a collision, and thus, the collisional risk can be reduced. Additionally, the worker or the like who is outside the object detection range of the truck 100 but is in the position where the truck 100 comes into view can recognize that the truck 100 has detected the object 200. Accordingly, for example, if the detected object 200 is the other party, the worker can alert the other party of danger, and if the detected object 200 is not a living object, the worker can take action to remove such object.

At this time, the color of the visible zone 300 is changed depending on the distance between the truck 100 and the object 200, so that the other party such as a pedestrian can intuitively and easily understand how close the truck 100 is to the other party and how dangerous the situation is.

Additionally, since the drive speed of the truck 100 is reduced and the truck 100 is stopped depending on the distance between the truck 100 and the object 200, not only can the alert be output but also the probability of the truck 100 colliding with the object 200 can further be reduced. At this time, when the distance between the truck 100 and the object 200 is longer than 10 meters in the driving direction, the truck 100 does not stop but reduces its drive speed and continues driving, and as a consequence, if the other party which is the object 200 can take action to avoid collision by the projection of the visible zone 300, the truck 100 can be back to normal driving mode without greatly affecting the driving of the truck 100. On the other hand, when the distance between the truck 100 and the object 200 is shorter than 10 meters in the driving direction, the vehicle stops rather than giving priority to driving so that safety can be ensured. Additionally, the electric parking brake is actuated when the truck 100 stops so that the truck 100 can stop safely even on a slope, for example.

When the distance between the truck 100 and the object 200 continues to be within 10 meters in the driving direction, that is, when the risk of the truck 100 colliding with the object continues, the autonomous driving control is canceled, and the autonomous driving control is resumed by manual operation only so that safety can further be improved.

The distance between the truck 100 and the object as the criteria for changing the alert mode may be freely set depending on the surrounding environment in the confined area, vehicle dimensions of the truck 100 and the like. Additionally, the colors of the visible zone 300 in the respective alert modes are not limited to the examples in the present embodiment. Furthermore, the drive speed in the “caution mode” may be freely set depending on the situation. Furthermore, the alert modes are not limited to three stages as in the present embodiment. For example, the “caution mode” may be further divided into a plurality of stages, and the visible zone 300 and the drive speed may be varied at each stage.

Furthermore, the output manner of the visible zone 300 is not limited to the method of changing colors depending on the alert mode. For example, the visible zone 300 can be displayed by blinking light, and the closer the truck 100 is to the object 200, the shorter the blinking interval can be, so that the other party can visually recognize the danger of how close the truck 100 is.

Furthermore, the projection range can be any range, although in the present embodiment, the visible zone 300 is projected such that the visible zone 300 in the driving direction of the truck 100 has longer projection range. Note that, for example, when the truck 100 is in the reverse gear, the driving direction of the truck 100 is backward, and the visible zone 300 may be projected such that the back of the truck 100 has longer projection range. Additionally, for example, the visible zone 300 may be projected such that the direction in which the object 200 is detected has longer projection range.

Furthermore, the projection range of the visible zone 300 may be the distance between the truck 100 and the object which is the criteria for changing the alert mode to the “pause mode”, for example. Accordingly, the other party which is the object 200 and others who are not recognized as the object 200 by the truck 100 can visually and clearly recognize the danger range where the probability of colliding with the truck 100 is high.

Next, the second embodiment of the present invention will be described. In the second embodiment, the truck 100 described in the first embodiment is one of the fleet of trucks in the confined area. When an object around the preceding vehicle is detected and an alert is made by the preceding vehicle, the alert is also made by the following vehicle. Accordingly, a person who works around the following vehicle can recognize that the following vehicle may also be restricted from driving as a consequence of the preceding vehicle being restricted from driving due to detection of the object.

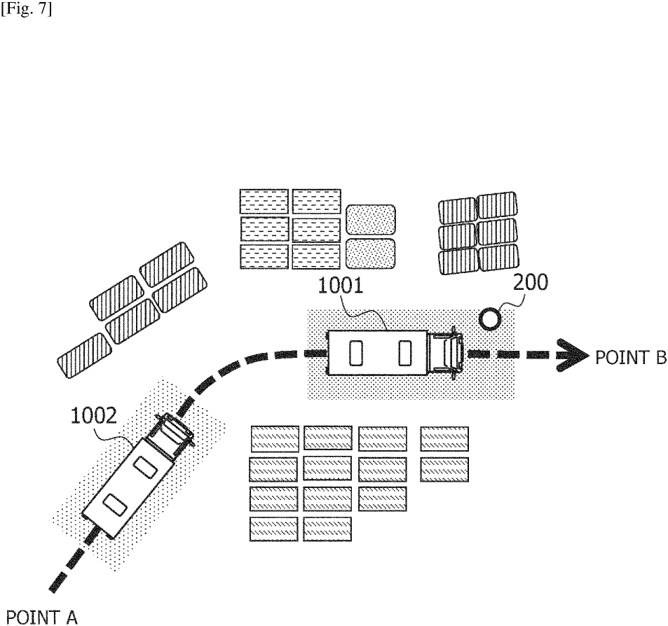

FIG. 7 is the explanatory view of platooning of the truck 100. In the present embodiment, trucks 1001 to 100N move from point A to point B through the same route and work on cargo transportation or the like. In FIG. 7, only the truck 1001 and the truck 1002 are illustrated. Similar to the first embodiment, the trucks 1001 to 100N are merely examples of the vehicles, and the vehicles may be any vehicle such as a construction machine, as long as the vehicle can run in the confined area. As illustrated in FIG. 7, when the object 200 is detected by the truck 1001 that is the preceding vehicle, the truck 1001 is restricted from driving, and consequently, the truck 1002 that is the following vehicle may also be restricted from driving. For example, when the truck 1001 projects the visible zone 300 in the “pause mode” and stops driving, the truck 1001 notifies of the alert mode to the truck 1002 through vehicle-to-vehicle communication. The truck 1002, upon receipt of the notice, projects the visible zone 300 in the alert mode that is determined based on the alert mode of the truck 1001. Accordingly, for example, a person who works around the truck 1002 in the confined area can visually recognize with ease that the truck 1002 is restricted from driving due to detection of the object 200 by the preceding vehicle.

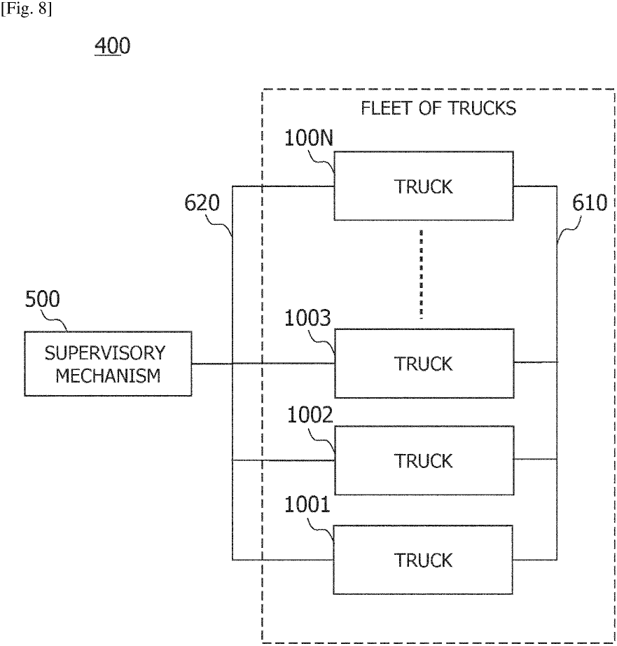

FIG. 8 is the configuration view illustrating the platooning system 400 according to the second embodiment. The platooning system 400 includes the trucks 1001 to 100N and a supervisory mechanism 500.

The trucks 1001 to 100N run in platoon formation on the same route in order. The trucks 1001 to 100N include a vehicle-to-vehicle communication device 171 as illustrated in FIG. 1, and are wirelessly connected to one another by a vehicle-to-vehicle (V2V) communication network 610 for mutually transmitting and receiving a variety of information through wireless communication.

The supervisory mechanism 500 is the server that supervises the group of vehicles of trucks 1001 to 100N. Each of the trucks 1001 to 100N includes the external communication device 172 as illustrated in FIG. 1, and each of them is wirelessly connected to the supervisory mechanism 500 via an external communication network 620. In the supervisory mechanism 500, the information received from the trucks 1001 to 100N via the external communication network 620 is displayed on the monitor, tablet and the like. The system supervisor monitors the driving of the trucks 1001 to 100N based on the information, and inputs the control instruction, as necessary. The control instruction is transmitted from the supervisory mechanism 500 to the trucks 1001 to 100N via the external communication network 620.

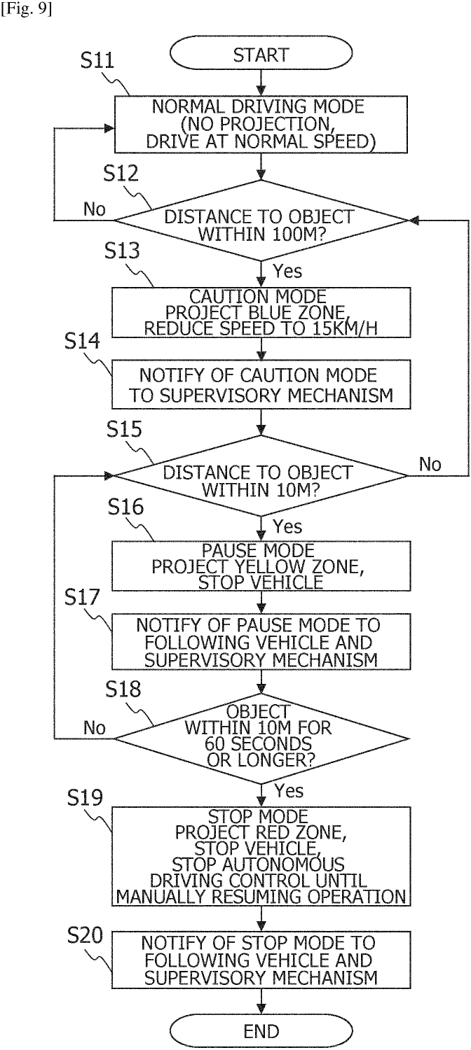

Next, in the second embodiment, the process executed by the alert output device 110 of the truck 1001 that is the preceding vehicle in the platoon will be described with reference to the flowchart of the process illustrated in FIG. 9.

Steps 11 to 13 are the same as Steps 1 to 4 in the first embodiment.

In Step 14, the alert output unit 113 uses the external communication device 172 to notify of the vehicle in the “caution mode” to the supervisory mechanism 500 via the external communication network 620. The alert output unit 113 continuously sends the notices at predetermined time intervals to the supervisory mechanism 500 while the vehicle is in the “caution mode”.

Steps 15 and 16 are the same as Steps 5 and 6 in the first embodiment.

In Step 17, the alert output unit 113 uses the vehicle-to-vehicle communication device 171 to notify of the vehicle in the “pause mode” to the truck 1002 which is the following vehicle that runs behind the vehicle via the vehicle-to-vehicle communication network 610. Furthermore, the alert output unit 113 uses the external communication device 172 to notify of the vehicle in the “pause mode” to the supervisory mechanism 500 via the external communication network 620. The alert output unit 113 continuously sends the notices at predetermined time intervals while the vehicle is in the “pause mode”.

Steps 18 and 19 are the same as Steps 7 and 8 in the first embodiment.

In Step 20, the alert output unit 113 uses the vehicle-to-vehicle communication device 171 to notify of the vehicle in the “stop mode” to the truck 1002 which is the following vehicle via the vehicle-to-vehicle communication network 610. Furthermore, the alert output unit 113 uses the external communication device 172 to notify of the vehicle in the “stop mode” to the supervisory mechanism 500 via the external communication network 620. The alert output unit 113 continuously sends the notices at predetermined time intervals while the vehicle is in the “stop mode”.

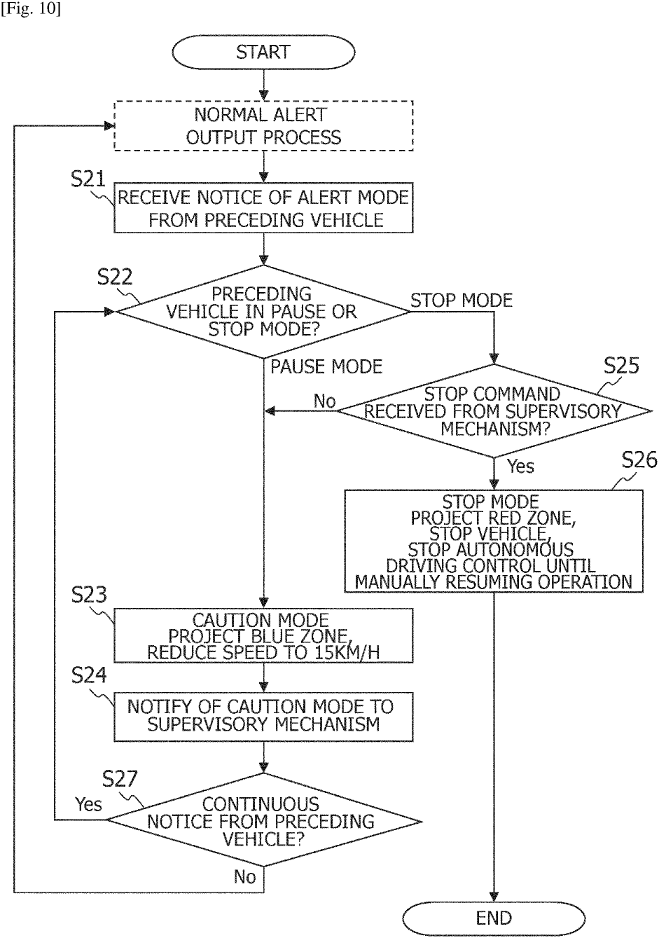

Next, the process executed by the alert output device 110 of the truck 1002 that is the following vehicle in the platoon will be described with reference to the flowchart of the process illustrated in FIG. 10.

First, the normal alert output process of the truck 100 as illustrated in FIG. 2 is performed in the truck 1002.

In Step 21, the alert mode determination unit 112 of the alert output device 110 receives the notice of the alert mode from the truck 1001 that is the preceding vehicle that runs ahead of the vehicle. As described above, the truck 1001 sends the notice to the truck 1002 when the vehicle is in the “pause mode” or “stop mode”.

In Step 22, the alert mode determination unit 112 determines whether the truck 1001 which is the preceding vehicle is in the pause mode or stop mode. If the truck 1001 is in the “pause mode”, the process proceeds to Step 23, and if the truck 1001 is in the “stop mode”, the process proceeds to Step 25.

In Step 23, the alert mode determination unit 112 determines the alert mode of the vehicle to be the “caution mode”. Then, the alert output unit 113 uses the projection device 131 to project the “blue” visible zone 300 surrounding the truck 1002 on its outside, and in order for the drive speed of the vehicle to be equal to or less than 15 km/h, the speed adjustment unit 114 outputs the control signal to the brake ECU 161 and outputs the control signal to the engine ECU 163, as necessary.

In Step 24, the alert output unit 113 uses the external communication device 172 to notify of the vehicle in the “caution mode” to the supervisory mechanism 500 via the external communication network 620.

In Step 25, the alert mode determination unit 112 determines whether the stop command is received from the supervisory mechanism 500. If the stop command is received, the process proceeds to Step 26 (Yes). Otherwise, the process proceeds to Step 23 (No), and the same process as the process that is performed when the notice of the “pause mode” is received from the truck 1001 is performed. Here, the alert mode determination unit 112 receives the stop command from the supervisory mechanism 500 when, for example, the supervisory mechanism 500 receives the notice of the “stop mode” from the truck 1001 that is the preceding vehicle, and the system supervisor, as a result of visually confirming the surrounding of the truck 1001, determines that the truck 1001 cannot run for the time being and thus, the following truck 1002 also needs to stop completely. Additionally, presetting is also possible in the supervisory mechanism 500 that when the notice of the “stop mode” is received from the preceding vehicle the “stop mode” is automatically entered in the following vehicle.

In Step 26, the alert mode determination unit 112 determines the alert mode of the vehicle to be the “stop mode”. Then, as illustrated in FIG. 6, the alert output unit 113 uses the projection device 131 to project the “red” visible zone 300 surrounding the truck 100 on its outside. Additionally, in order to stop the vehicle, the speed adjustment unit 114 outputs the control signal to the brake ECU 161 and outputs the control signal to the engine ECU 163, as necessary. At this time, the control signal for disengaging the clutch may be transmitted to the transmission ECU (not shown), as necessary. Furthermore, the stop control unit 115 outputs the control signal for actuating the electric parking brake to the EPB ECU 165. Then, the stop control unit 115 outputs the control signal for canceling the autonomous driving control to the autonomous driving control device 141.

In Step 27, the alert mode determination unit 112 determines, at predetermined time intervals, whether or not the alert mode is continuously notified from the truck 1001. When the alert mode is continuously notified, the process returns to Step 22 (Yes). When the alert mode is no longer notified, the alert output state is canceled, the vehicle is back to the normal driving mode, and the normal alert output process is performed.

According to the second embodiment, the object 200 is detected by the truck 1001 and the visible zone 300 is projected depending on the alert mode, and in conjunction with this, the visible zone 300 of the truck 1002 that is the following vehicle of the truck 1001 can also be projected. Therefore, a person who works around the truck 1002 in the confined area can visually recognize with ease that the truck 1002 is restricted from driving due to detection of the object 200 by the preceding vehicle. The projection range of the visible zone 300 of the following vehicle may also be any range, and may be narrower than that of the preceding vehicle, for example.

Furthermore, in the present embodiment, the truck 1001 reduces its driving speed or stops driving depending on the alert mode, and in conjunction with this, the truck 1002 also reduces its driving speed or stops driving so that the distance between the truck 1001 and the truck 1002 can also be appropriately maintained.

In the present embodiment, at the time the truck 1001 is in the “caution mode”, the notice is only sent to the supervisory mechanism 500; however, the notice can also be sent to the truck 1002 at this stage as a matter of course. Consequently, the truck 1002 may also enter the “caution mode”. Similarly, when the truck 1002 receives the notice that the truck 1001 is in the “pause mode” or “stop mode”, the truck 1002 may also enter the “pause mode” or “stop mode” in the same manner as the truck 1001. These alert modes can be freely selected and set by the system supervisor or user. Additionally, unlike the above process, in the case if the truck 1002 does not enter the “caution mode” and does not reduces its driving speed, when the truck 1001 is in the “pause mode” or “stop mode”, the truck 1002 performs the normal alert output process. Thus, if the truck 1002 approaches the truck 1001, the truck 1002 detects the truck 1001 as the object and performs speed reduction and stop processes so that the collision can be avoided.

Similarly, the control instruction from the supervisory mechanism 500 to the truck 1002 is not limited to the above-described process, and can be freely performed by the system supervisor or user depending on the driving of the truck 1001.

When the truck 1002 that is the following vehicle receives the notice of the alert mode from the truck 1001 that is the preceding vehicle, the truck 1002 may further notify of the alert mode to the truck 1003 that is the following vehicle of the truck 1002. Consequently, the same process as in the truck 1002 may also be performed in the truck 1003. Also, up to how many vehicles from the truck 1001 where the object is detected are notified of the alert mode can be set in advance, so that the number of vehicles based on the setting may be notified of the alert mode.

Additionally, not only in cases in which the truck 100 that runs in the confined area performs platooning but also in cases in which the plurality of trucks 100 runs individually, each of the trucks 100 may use the external communication device 172 to notify of the alert mode to the supervisory mechanism 500 via the external communication network 620. Accordingly, the system supervisor can notify of the alert to the other trucks 100 that are driving nearby, and can further improve safety in the entire confined area.

One skilled in the art will readily understand that a new embodiment can be made by omitting a part of the technical idea of the various embodiments, freely combining parts of the technical idea of the various embodiments, and substituting a part of the technical idea of the various embodiments.

REFERENCE SIGNS LIST

| | |
|---|---|
| 100 | Truck |
| 110 | Alert output device |
| 111 | Object detection unit |
| 112 | Alert mode determination unit |
| 113 | Alert output unit |
| 114 | Speed adjustment unit |
| 115 | Stop control unit |
| 121 | Camera |
| 122 | Radar |
| 123 | Lidar |
| 131 | Projection device |
| 141 | Autonomous driving control device |
| 161 | Brake ECU |
| 163 | Engine ECU |
| 165 | EPB ECU |
| 200 | Object |
| 300 | Visible zone |
| 400 | Platooning system |
| 500 | Supervisory mechanism |

1. An alert output method for an autonomous driving vehicle that runs in a confined area, the method comprising the steps of:
detecting an object around the vehicle by a sensing device;
determining an alert mode depending on a distance between the vehicle and the object; and
projecting a visible zone surrounding the vehicle on an outside of the vehicle by a projection device in a manner corresponding to the alert mode.

2. The alert output method claim 1, wherein the step of projecting the visible zone changes colors of the visible zone depending on the alert mode.

3. The alert output method of claim 1, wherein the step of projecting the visible zone projects the visible zone such that the visible zone in a driving direction of the vehicle is longer than in other directions.

4. The alert output method of claim 1, further comprising the step of outputting a control signal to a control device that is related to driving of the vehicle such that the vehicle runs at a predetermined speed or less depending on the alert mode.

5. The alert output method of claim 4, wherein the step of outputting the control signal outputs the control signal to the control device that is related to driving of the vehicle such that the vehicle stops when the distance to the object is within a predetermined range.

6. The alert output method of claim 5, wherein the predetermined range is a projection range of the visible zone.

7. The alert output method claim 5, wherein the step of outputting the control signal activates an electric parking brake when the vehicle stops.

8. The alert output methodof claim 5, wherein the step of outputting the control signal cancels autonomous driving control of the vehicle when the distance to the object continues to be within the predetermined range for a predetermined period of time or longer and resumes the autonomous driving control by manual operation only.

9. The alert output method of claim 1, further comprising the step of notifying of the alert mode to a following vehicle that runs behind the vehicle,
wherein upon receipt of information indicating the alert mode of a preceding vehicle that runs ahead of the vehicle, the visible zone surrounding the vehicle on its outside is projected by the projection device in a manner corresponding to an alert mode that is determined based on the alert mode of the preceding vehicle in the projecting step.

10. The alert output method of claim 1, further comprising the step of notifying of the alert mode to a system for supervising a group of vehicles that runs in the confined area.

11. An alert output device configured to perform the steps of claim 1.

12. A computer program including a program code that performs the steps according to claim 1 when executed on a computer.

13. A computer readable medium that holds a computer program that includes a program code that the steps of claim 1 when executed on a computer.

14. An alert output system equipped on an autonomous driving vehicle that runs in a confined area, the system comprising:
a sensing device that detects an object around the vehicle;
a projection device that projects a visible zone surrounding the vehicle on its outside; and
an alert output device that detects the object by the sensing device, determines an alert mode depending on a distance between the vehicle and the object, and projects the visible zone in a manner corresponding to the alert mode by the projection device.

15. A vehicle equipped with the alert output system of claim 14.
